(19) United States
(12) Patent Application Publication
(10) Pub. No.: US 2013/0117077 A1
(43) Pub. Date: May 9, 2013

(54) PARKING AVAILABILITY DETECTION WITH HUMAN SENSING

(71) Applicants: Faming Li, Solon, OH (US); Yu-An Sun, Webster, NY (US); John C. Handley, Fairport, NY (US)

(72) Inventors: Faming Li, Solon, OH (US); Yu-An Sun, Webster, NY (US); John C. Handley, Fairport, NY (US)

(73) Assignee: Xerox Corporation, Norwalk, CT (US)

(21) Appl. No.: 13/289,600

(22) Filed: Nov. 4, 2011

(51) Int. Cl. G07B 15/00

(52) U.S. Cl. 705/13

(57) ABSTRACT

Providing means for people to input their observations can reduce the need for sensor deployments because humans have excellent sensing abilities. One thing people tend to observe carefully is parking availability. Parking meters and pay stations can request people to enter their observations of parking availability and other environmental factors. The observations, being numerical in nature, can be processed to determine reasonable parking fees, likelihood of violators in an area, and the statistical, observed, or estimated dispersion of available parking with a geographic region.

Embodiments are related to parking meters, parking pay stations, networked computers, geolocation, and decision and estimation theory.

### BACKGROUND

In the past, urban parking was managed by placing parking meters along the street and setting a price. Enforcement has been a matter of sending a person out to locate violators and to write them tickets. There have been efforts to automate the detection of parking violations as is taught in U.S. Pat. Nos. 6,037,880 and 6,791,473 wherein parking spaces or meters are outfitted with sensors and communications nodes for automatically detecting violators. Other efforts target ease of payment such as U.S. Pat. No. 6,970,850 and U.S. Patent Pub. No. 2010/0090865 which teach assisted or automated parking fee payment.

FIG. 1, labeled as “Prior Art”, illustrates a current technology parking payment station 101. A user interface can have a keypad 107 and a display 108. The display 108 can indicate various parking rates 105, show input fields where data may be entered, and provide feedback for various user selections and actions. The keypad 108 can accept numeric, and sometimes even alphanumeric, input from a person 115. The displayed parking rates can be simply an output field indicating parking rates 115 electronically stored within the parking payment station 101.

A payment module 102 can accept and process payments. A cash module 103 can accept money payments such as coins or paper money. A credit card module 104 can include a card reader and computer software for interacting with a payment processor 110 though a communications network 109 such as the internet or a private network. Other devices and systems 111 can be, and almost always are, connected to the communications network 111.

A violation module 112 can include a violation timer 113 that determines when the period of paid parking has elapsed such that a vehicle in the associated parking spot is in parking violation. A violation indictor 114 can show that a violation may be occurring. The violation indicator is typically a flag or brightly colored item that becomes visible upon violation such that a parking attendant or enforcer can see the violation indicator 114 from a distance.

The prior art solutions have one thing in common. Parking spots are instrumented to detect the presence or absence of vehicles with the aim of collecting payment or issuing violations. A large scale roll out of such sensing is a very costly proposition. Systems and methods that rely on sensors that are already available are needed.

### BRIEF SUMMARY

Aspects of the embodiments address limitations and flaws in the prior art by allowing people to report observations such as parking availability and by analyzing the input data to help determine the value of parking at different locations and times.

It is therefore an aspect of the embodiments to provide a parking station that has a user interface (UI) for collecting a person's observations. Many parking stations already have a user interface for collecting payment for given certain over various time periods. The observation input UI can easily be added as additional input fields, as an additional page displayed by the UI, or as an additional display. A parking occupancy input can take various forms ranging from a slider bar going from 0% to 100%, arrows for indicating more or less, or textual input. The user input can be obtained from physical buttons, knobs, or keypads or from more abstract ones provided by a touch or multi-touch sensitive surface. Many embodiments can have optional inputs because some people would rather not provide the information. Note that a parking station can cover a single parking spot, as with a parking meter, or can cover many spots.

It is also an aspect of the embodiments that a violation module detects a parking violation and a violation indicator that indicates a parking violation. The violation module need not detect if there is a vehicle parked in a space but must detect that the amount of time paid for has elapsed and that a vehicle in a parking space is in violation and should be ticketed.

It is also an aspect of the embodiments that a payment module accepts payment of the parking fee. The payment station can indicate parking rates that are determined by a pricing module. Parking rates can be a constant amount per time period such as $1 per hour or can vary such as $1 for 1 hour or $5 for 8 hours. Parking rates can also change based on the time of day. The payment station can receive updated rates through a communications network to thereby adapt parking rates on a dynamic basis. Another alternative is that the pricing module automatically changes the parking rates based on an occupancy estimate.

An occupancy estimation module can produce the occupancy estimate based on the reported occupancy from the parking occupancy input as well as other environmental factors such as time of day, day of week, week of year, temperature, precipitation, etc. For example, the last parking space at 8:15 AM on a work day in the rain can be very valuable whereas a weekend spot in a near empty lot may not be. Furthermore, some municipalities occasionally have ‘free parking’ in association with a celebration, neighborhood event, or local promotion. Historical occupancy data an environmental can also be used to predict or estimate the market demand for parking.

It is an aspect of some embodiments that a data rejection module rejects the reported occupancy when it does not agree with other data. For example, the reported occupancy can be steadily reported at approximately 75% except for a single 5% input. The outlier can be rejected. Similarly, the environmental or historical data can be used for rejecting spurious inputs as well as for detecting and predicting trends. Those practiced in art of decision and estimation theory know of numerous closed form and adaptive estimation techniques for producing occupancy estimates and detecting spurious inputs.

Certain embodiments can ask people to report observations other than reported occupancy. Those observations can include reported time to find parking, and distance from best parking spot.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the background of the invention, brief summary of the invention, and detailed description of the invention, serve to explain the principles of the present invention.

FIG. 1, labeled as “Prior Art”, illustrates a current technology parking payment station;

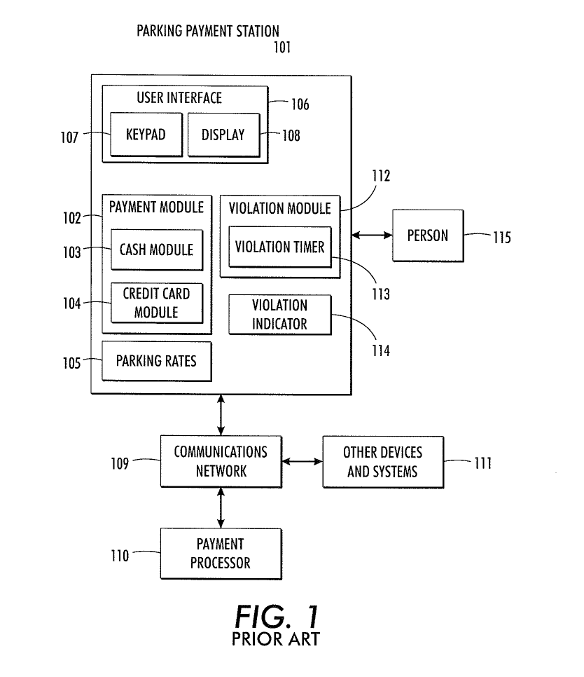

FIG. 2 illustrates a parking payment station with provisions for accepting user observations, evaluating them, and setting prices in accordance with aspects of some embodiments; and

FIG. 3 illustrates a parking payment system with parking payment stations and a server with provisions for accepting user observations, evaluating them, and setting prices in accordance with aspects of some embodiments.

### DETAILED DESCRIPTION OF THE INVENTION

The particular values and configurations discussed in these non-limiting examples can be varied and are cited merely to illustrate embodiments and are not intended to limit the scope of the invention.

Providing means for people to input their observations can reduce the need for sensor deployments because humans have excellent sensing abilities. One thing people tend to observe carefully is parking availability. Parking meters and pay stations can request people to enter their observations of parking availability and other environmental factors. The observations, being numerical or discrete in nature, can be processed to determine reasonable parking fees, likelihood of violators in an area, and the statistical, observed, or estimated dispersion of available parking with a geographic region.

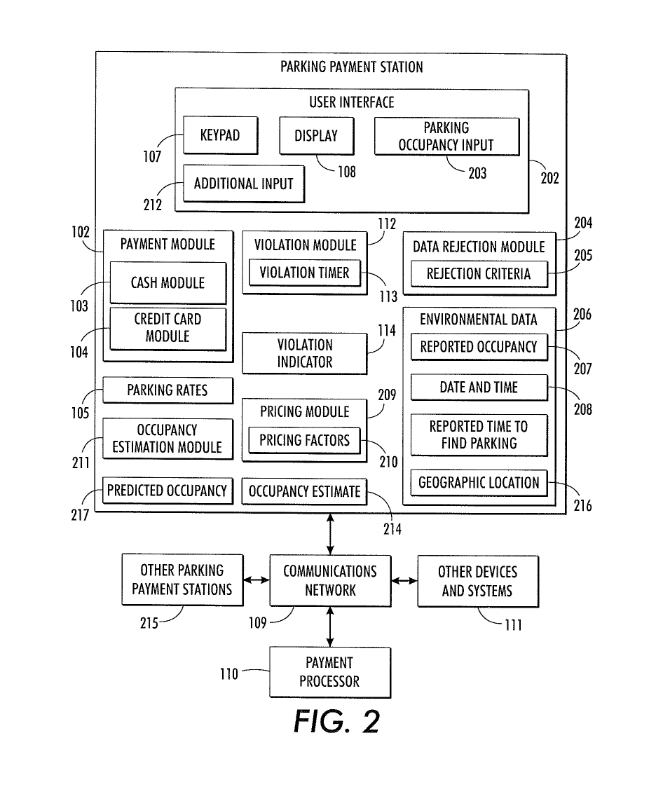

FIG. 2 illustrates a parking payment station 201 with provisions for accepting user observations, evaluating them, and setting prices in accordance with aspects of some embodiments. The user interface 202 includes a parking occupancy input 203 and can request other data through additional inputs 212. Note that many current generation marking meters and payment stations can provide the new UI elements and other aspects of the embodiments through software update.

A data rejection module 204 can receive the person's reported observations and reject them if they do not meet defined rejection criteria 205. The rejection criteria can be as simple as outlier detection, too different from other recent observations, distance from a moving average (or median), or some other method. A further criterion can be too far from an occupancy estimate 214. The generalizations “too far” or “too different” can be quantified with known numerical methods such as thresholding. The inventors have applied a filtering technique with favorable results to real parking data. The reported occupancies were treated as a low frequency time series and a median filter followed by a low pass filter. The filtering cleaned away outliers and the filtered data was very close to the actual occupancies. This approach makes sense because parking occupancy does vary slowly with time and with people's activities such as going to breakfast, work, lunch, dinner, and home.

The occupancy estimate 214 can be produced by an occupancy estimation module 211. The occupancy estimation module can produce an occupancy estimate 214 from environmental data 206 that can include reported occupancy 207, date and time 208, reported time to find parking 213, and geographic location 216. Note that reported occupancy 207 cab be entered by a person into the parking occupancy input 203. The occupancy estimate 214 is an estimate of the current parking availability and can be used by a pricing module 209 to amend the parking rates 105. The difference between the occupancy estimate 214 and the reported occupancy 207 can be considered an error measurement that can be fed back into the occupancy estimation module 211 as a corrective input. A reason for producing an occupancy estimate is that the reported observations start getting stale as soon as the person parks while the pricing rates 105 are ideally more dependent on current or future values.

The occupancy estimation module 211 can also produce a predicted occupancy 217. For example, historical data including environmental data 206, occupancy estimates 214, and/or predicted occupancies 217 from previous time periods can be used to predict parking availability at future times. For example, there can be ample parking at 7 AM on a workday and the occupancy estimate and reported occupancy can accurately indicate the situation. The predicted occupancy 217, however, can indicate that parking will be in high demand within an hour. As such, the parking rates 105 can be increased ahead of the high demand instead of waiting until the high demand situation materializes. Corrective inputs for the predicted occupancy can also be fed back into the occupancy estimation module 211.

The parking payment station 201 can be in communication with other parking payment stations 215. The geographic locations of the payment stations and the reported occupancies can be processed to determine parking availability in a region larger than that covered by a single payment station.

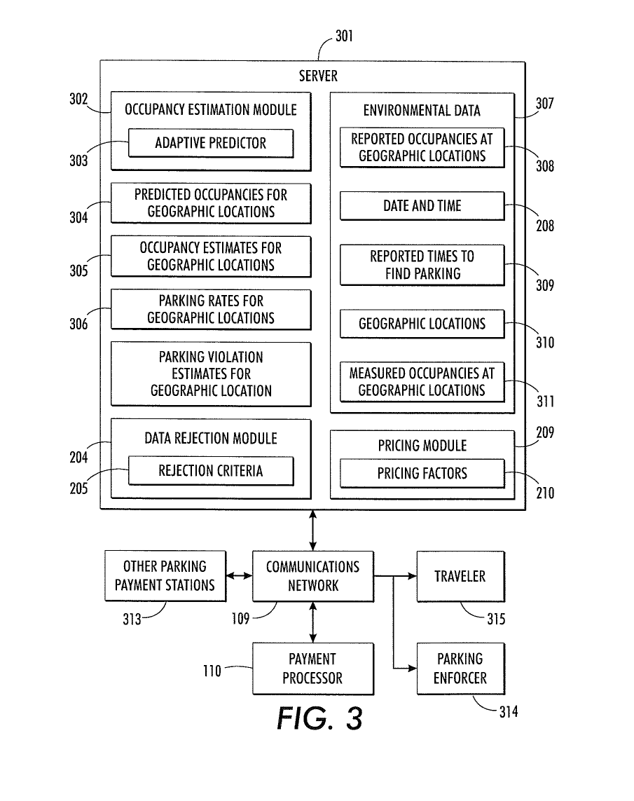

FIG. 2 illustrates that the observation data can be processed locally. For example, one of the payment stations can process the data for its own use or can process the data and pass the results to nearby payment stations. Another alternative is the observation data processing and modules can be distributed amongst a group of payment stations. FIG. 3 illustrates that servers can also participate in the observation data processing. For example, all of the data processing can be performed at a central location by one or more servers and the results passed back to the payment stations.

FIG. 3 illustrates a parking payment system with parking payment stations and a server with provisions for accepting user observations, evaluating them, and setting prices in accordance with aspects of some embodiments. The system of FIG. 3 is, essentially, an explicit adaptation of the FIG. 2 system for managing parking in larger geographic regions. The server 301 is in communication with numerous parking payment stations 313 at various geographic locations 310. The environmental data 307 can have data specifically associated with the geographic locations such as reported occupancies 308 and reported times to find parking 309. Measured occupancies 311 are inputs obtained by more qualified people or means such as a parking enforcer 314 or a current satellite or video image.

The occupancy estimation module 302 is now illustrated with an adaptive predictor 303. An adaptive predictor 303 can accept the corrective inputs mentioned above such that its future estimates and predictions are more accurate. Those familiar with decision and estimation theory, signal processing, adaptive signal processing, machine learning, and linear system theory know of a wide variety of adaptive predictors.

The occupancy estimation module 302 can also produce predicted occupancies 304 and occupancy estimates 305 for different geographic locations or regions. For example, high parking demand can flow from area to area during the day moving from business districts to restaurant districts to housing districts. As such, parking rates for geographic locations 306 can be varied during the day to meet or counter predicted and actual demand. Predicted parking rates can be produced for future time periods in the various geographic areas.

The reported, estimated, or predicted parking availability as well as the current and predicted parking rates can be gathered and presented as a service to a traveler 315 to thereby guide the traveler 315 to a good area. The traveler may want cheap parking or may want immediate parking. In any case, the data can be made available, perhaps for a one-time or a subscription fee.

Parking violation modules contain data indicating that parking has been paid for and when the paid for time periods elapse. That data can be combined with the various occupancy reports, estimations, and predictions to discover where parking violations are likely to be occurring and where they are likely to occur. For example, the data can indicate that only 30% of the parking is currently being paid for while the occupancy appears to be at least 50%. The 20% difference implies there are parking violations. A parking violation estimation module can produce parking violation estimates for the geographic locations 312. The violation estimates and predictions can be provided to a parking enforcer 314 who can then select where to go to issue tickets.

Embodiments can be implemented in the context of modules. In the computer programming arts, a module can be typically implemented as a collection of routines and data structures that performs particular tasks or implements a particular abstract data type. Modules generally can be composed of two parts. First, a software module may list the constants, data types, variable, routines and the like that that can be accessed by other modules or routines. Second, a software module can be configured as an implementation, which can be private (i.e., accessible perhaps only to the module), and that contains the source code that actually implements the routines or subroutines upon which the module is based. Thus, for example, the term module, as utilized herein generally refers to software modules or implementations thereof. Such modules can be utilized separately or together to form a program product that can be implemented through signal-bearing media, including transmission media and recordable media.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims:

1. A system comprising:
a parking payment station comprising a user interface wherein the user interface comprises a parking occupancy input that accepts a reported occupancy from a person, and wherein the parking payment station indicates at least one parking rate;
a violation module that detects a parking violation;
a violation indicator that indicates the parking violation;
a payment module that accepts payment and determines when the next parking violation will occur for a particular parking spot; and
a pricing module that determines the at least one parking rate.

2. The system of claim 1 further comprising an occupancy estimation module that produces an occupancy estimate based on environmental data comprising the reported occupancy and wherein the pricing module amends the at least one parking rate based on a plurality of pricing factors that comprise the occupancy estimate.

3. The system of claim 2 wherein the environmental data further comprises historical occupancy data, time of day, and date.

4. The system of claim 2 further comprising a data rejection module that rejects the reported occupancy based on rejection criteria comprising the environmental data.

5. The system of claim 2 wherein the user interface further comprises an additional input for accepting a reported time to find parking and wherein the pricing factors further comprise the occupancy estimate and the reported time to find parking.

6. The system of claim 1 wherein inputing the reported occupancy is optional.

7. A system comprising:
a plurality of parking payment stations connected to a communications network wherein the parking payment stations each comprise a user interface comprising a parking occupancy input that accepts a reported occupancy from a person, wherein the parking payment stations each are associated with a geographic location, and wherein the parking payment stations indicate at least one parking rate;
a violation module that indicates a parking violation;
a violation indicator that indicates the parking violation;
a payment module that accepts payment and determines when the next parking violation will occur for a particular parking spot; and
a pricing module that determines the at least one parking rate.

8. The system of claim 7 further comprising an occupancy estimation module that produces an occupancy estimate based on environmental data comprising the reported occupancies and the geographic locations, and wherein the pricing module amends the at least one parking rate based on a plurality of pricing factors that comprise the occupancy estimate.

9. The system of claim 8 wherein the occupancy estimate is a geographically varying occupancy estimate and wherein the at least one parking rate varies with geographic location.

10. A system comprising:
a server connected to a communications network;
a plurality of parking payment stations connected to a communications network wherein the parking payment stations comprise a plurality of user interfaces comprising a parking occupancy input field that accept a plurality of reported occupancies from people, wherein the parking payment stations are associated with a plurality of geographic locations, and wherein the parking payment stations indicate at least one parking rate;
a violation module that indicates a parking violation;
a violation indicator that indicates the parking violation;
a payment module that accepts payment and determines when the next parking violation will occur for a particular parking spot; and
a pricing module that determines the at least one parking rate.

11. The system of claim 10 further comprising an occupancy estimation module that produces a geographically varying occupancy estimate based on environmental data comprising the reported occupancies at the geographic locations.

12. The system of claim 11 wherein the at least one parking rate varies with geographic location and wherein the pricing module amends the at least one parking rate based on a plurality of pricing factors that comprise the occupancy estimate.

13. The system of claim 12 wherein the server publishes the at least one parking rate to thereby provide a traveler with parking information.

14. The system of claim 11 wherein the server publishes the occupancy estimate to thereby provide a traveler with parking information.

15. The system of claim 11 further comprising a geographically varying parking violation estimate that provides guidance to a parking enforcer.

16. The system of claim 10 further comprising an occupancy estimation module that produces a geographically varying occupancy estimate and a geographically varying predicted occupancy based on environmental data comprising the reported occupancies, the geographic locations, the date, the time, and historical occupancy data, and wherein the predicted occupancy is a prediction of parking occupancy at a future time that is at least 15 minutes in the future.

17. The system of claim 16 wherein the occupancy estimation module comprises and adaptive predictor that automatically attempts to minimize the difference between the predicted occupancy and the occupancy estimate or a measured occupancy at the future time.

18. The system of claim 16 wherein the at least one parking rate varies with geographic location and wherein the pricing module amends the least one parking rate based on a plurality of pricing factors that comprise the predicted occupancy.

19. The system of claim 18 wherein the server publishes the at least one parking rate and the predicted occupancy to thereby provide a traveler with parking information.

20. The system of claim 16 further comprising a geographically varying parking violation prediction based on violation prediction factors that comprise the predicted occupancy to thereby provide guidance to a parking enforcer.
